(19) United States
(12) Patent Application Publication
(10) Pub. No.: US 2024/0402100 A1
(43) Pub. Date: Dec. 5, 2024

(54) Scanning System and Method for Scanning Vessels

(71) Applicant: Tracerco Limited, London (GB)

(72) Inventors: Thomas Evans, Billingham Cleveland (GB); Peter James Umpleby, Billingham Cleveland (GB)

(73) Assignee: Tracerco Limited, London (GB)

(21) Appl. No.: 18/696,900

(22) PCT Filed: Jul. 18, 2022
(86) PCT No.: PCT/GB2022/051851

§ 371 Date: Mar. 28, 2024

(30) Foreign Application Priority Data
Oct. 1, 2021 (GB) 2114070.2

(51) Int. Cl. G01N 23/095

(52) U.S. Cl. CPC G01N 23/095

(57) ABSTRACT

A method of scanning a chemical processing vessel and diagnosing a problem within the chemical processing vessel and/or a problem with a process occurring within the chemical processing vessel, the method comprising: scanning the chemical processing vessel with at least one radiation source and at least one detector to generate density profile data for the chemical processing vessel; saving the density profile data; generating a representation of the chemical processing vessel; associating the density profile data with the representation of the chemical processing vessel whereby each data point of the density profile data is associated with a corresponding location along the representation of the chemical processing vessel indicating the location from which the data point was obtained; displaying the representation of the chemical processing vessel alongside the associated density profile data on a user interface, wherein the user interface is configured to enable a user to select a portion of the representation of the chemical processing vessel on the user interface and to automatically display a corresponding portion of the density profile data in expanded form, whereby said portion of the density profile data can be analysed by the user in greater detail.

### FIELD

The present specification relates to a scanning system and method for scanning chemical processing vessels, particularly for scanning vessels which are large, tall and/or elongate, and particularly for vessels which are sealed, and which cannot be easily accessed without disrupting the chemical processes occurring within the vessels. Examples of such chemical processing vessels include towers and tanks on industrial chemical sites, e.g. distillation towers, storage tanks, separator vessels, and the like.

### BACKGROUND

It is known to conduct scans of industrial chemical vessels, such as distillation towers on petrochemical sites, using a technique called gamma scanning. In this technique a radioactive isotope emitting gamma radiation and a detector are lowered down two opposing sides of a tower to measure the density inside the tower at various different heights. Gamma radiation is transmitted through the tower from the radioactive source on one side of the tower to the detector on an opposite side of the tower. Attenuation of the gamma radiation as it passes through the tower is dependent on the density of the material through which the radiation passes. As such, a density profile of the tower can be generated, and this can be used to diagnose problems with the tower and/or the process operating in the tower without opening the tower and/or stopping the process. For example, it is possible to identify the location of different fluid layers having different densities in a multi-layer fluid column comprising, for example, layers of solid, aqueous, emulsion, oil, and/or gas phases. For certain chemical processes it is required to maintain a fluid surface or interface at a specific height within a tower. The gamma scanning technique allows the interior of a tower to be interrogated to determine correct operating conditions and/or diagnose a problem in the tower.

Gamma scans can be performed by lowering a source and a detector down a tower on a winch system. As an alternative to using a single radiation source and detector which are moved down the tower in unison to measure a density profile of the tower, an array of radiation sources and detectors can be provided extending down on opposite sides of the tower to provide source/detector pairs at fixed locations down the tower. In order to obtain the required measurement accuracy, such a system adopts a collimated design which ensures that each source/detector pair is focused at a particular elevation. In this way, a density profile of the tower can be generated in a similar fashion to scanning with a single source and detector pair.

Such equipment can be installed and operated periodically to monitor a tower, or the equipment may be installed and operated when a problem occurs within a tower which requires diagnosis. As an alternative, the equipment can be permanently installed on a tower.

In addition to the density profile measurements on a tower as outlined above, it is also known to take computed tomography (CT) gamma scanning measurements of a tower. CT gamma scanning involves locating a radiation source on one side of the tower and a detector on the other side of the tower. The source and detector are then moved around the circumference of the tower taking measurement at a plurality of radial directions around the tower. Reconstruction models then take this information and use it to generate an accurate image of the tower at that location. This has the advantage of generating a density map which can provide information about the tower wall thickness and integrity, the product flowing conditions, and the condition of any coating applied to the tower. CT scans can be performed at multiple heights down the tower to build a three-dimensional picture of the tower interior.

The scanning systems and methods as described above can generate a large amount of density profile data about an industrial chemical processing vessel and/or a chemical process operating within the vessel. This data must be analysed to diagnose problems within the vessel and/or the process operating within the vessel. While it may be evident from the overall operating functionality of a chemical vessel and/or process that there is a problem, it is not always straightforward to identify what the problem is, where the problem is occurring within a vessel, and/or how the vessel and/or process has deviated from its intended operating conditions.

Traditionally, the entirety of the scanning data is reviewed by a skilled operator to try to identify anomalies which may be indicative of a problem at a location within an industrial chemical processing vessel. However, this is time consuming and difficult, especially given the size of industrial chemical processing vessels and the vast quantity of data which is generated during a scanning operation. For example, tower scan reports are currently paper documents or PDF files that cannot easily be compared and/or manipulated to pin-point anomalies.

It is an aim of the present specification to provide an improved system and method for scanning vessels, such as industrial chemical towers distillation towers, storage tanks, separator vessels, and the like, and for analysing scanning data to diagnose a problem.

### SUMMARY OF INVENTION

According to the present specification there is provided a method of scanning a chemical processing vessel and diagnosing a problem within the chemical processing vessel and/or a problem with a process occurring within the chemical processing vessel, the method comprising:
scanning the chemical processing vessel with at least one radiation source and at least one detector to generate density profile data for the chemical processing vessel;
saving the density profile data;
generating a representation of the chemical processing vessel;
associating the density profile data with the representation of the chemical processing vessel whereby each data point of the density profile data is associated with a corresponding location along the representation of the chemical processing vessel indicating the location from which the data point was obtained;
displaying the representation of the chemical processing vessel alongside the associated density profile data on a user interface,
wherein the user interface is configured to enable a user to select a portion of the representation of the chemical processing vessel on the user interface and to automatically display a corresponding portion of the density profile data in expanded form, whereby said portion of the density profile data can be analysed by the user in greater detail.

This method enables a user or customer to interactively take a deeper dive into scan data and more quickly, easily, and reliably locate, identify, and diagnose any problems within the chemical processing vessel. By “chemical processing vessel” we mean any vessel which is used to process (including storage) any solid, liquid, or gaseous chemical(s), or mixtures or layers thereof. Examples of applications include oil and gas, alcohols, bio-fuels, liquids storage etc.

Advantageously, the method further comprises associating the saved density profile data with a date (and/or optionally time) on which the density profile data was captured, wherein the user interface is configured to enable a user to simultaneously display density profile data captured on two or more different dates (and/or times) to identify changes in the density profile data associated with a representation of chemical processing vessel. For example, the user interface can be configured to enable a user to select a portion of the representation of the chemical processing vessel on the user interface and to automatically display a corresponding portion of the density profile data in expanded form for said two or more different dates, whereby said portion of the density profile data for said two or more different dates can be analysed by the user in greater detail to identify changes in said portion of the density profile data. The density profile data captured on two or more different dates may be displayed side-by-side and aligned such that adjacent density profile data corresponds to the same location along the chemical processing vessel. Alternatively, the density profile data captured on two or more different dates may be displayed in overlayed form and aligned such that adjacent density profile data corresponds to the same location along the chemical processing vessel.

Once historical data has been built up for a customer's chemical processing vessel asset, the interactive functionality of the present method can be used to build a comparison between datasets by importing previous comparable reports on the asset and displaying historic data overlaid or side-by-side dependent on the view.

Typically, the representation of the chemical processing vessel displayed on the user interface is a longitudinal representation of the chemical process vessel. However, the user interface can be configured to enable a user to select a portion of the longitudinal representation of the chemical processing vessel and to display a cross-sectional representation of the selected portion along with density profile data for said cross-sectional representation. In this case, the density profile data can include density data captured at different angular orientations around the chemical processing vessel, and the user interface can be configured to display density data captured at different angular orientations around the chemical processing vessel for the selected portion of the longitudinal representation of the chemical processing vessel.

The present method is particularly suited for scanning methods which generate a density profile of a chemical processing vessel from the exterior of the vessel without opening the vessel and/or stopping the process. In such methods, the or each radiation source is typically a gamma radiation source. Without having access to the vessel in order to view the interior thereof, the present method provides an interactive way to more quickly, easily, and reliably locate, identify, and diagnose any problems within the chemical processing vessel. The method may be applied to distillation towers, chemical storage tanks, separator vessels, and the like. The method may further comprise controlling the chemical processing vessel and/or the process occurring within the chemical processing vessel based on said analysis. For example, operating parameters for the vessel and/or process can be changed based on said analysis to correct a problem with the way that the vessel and/or process is operating, e.g., to alter the position of an interface between two fluids within the vessel.

The present specification also provides a scanning system for scanning a chemical processing vessel and diagnosing a problem within the chemical processing vessel and/or a problem with a process occurring within the chemical processing vessel, the scanning system comprising:
a scanning apparatus comprising at least one radiation source and at least one detector configured to enable scanning of the chemical processing vessel to generate density profile data for the chemical processing vessel;
a computing system comprising a data storage for storing the density profile data, a processor for processing the density profile data, and a display for displaying a user interface configured to enable a user to select and view the density profile data on the display; and
data processing software configured to generate the user interface and implement the method as described herein for diagnosing a problem within the chemical processing vessel and/or a problem with a process occurring within the chemical processing vessel.

The present specification also provides a computer program configured to implement the method as described herein for diagnosing a problem within a chemical processing vessel and/or a problem with a process occurring within the chemical processing vessel.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a schematic representation of a scanning system for scanning a chemical processing vessel and diagnosing a problem within the chemical processing vessel and/or a problem with a process occurring within the chemical processing vessel;

FIG. 2 is a screen shot of a user interface showing a report cover;

FIG. 3 is a screen shot of a user interface showing a default report view;

FIG. 4 is a screen shot of a user interface showing a scanline filtering view;

FIG. 5 is a screen shot of a user interface showing an orientation view;

FIG. 6 is a screen shot of a user interface showing a FrothView™;

FIG. 7 is a screen shot of a user interface showing a commenting view;

FIG. 8 is a screen shot of a user interface showing a first comparison set-up;

FIG. 9 is a screen shot of a user interface showing a second comparison set-up;

FIG. 10 is a screen shot of a user interface showing a third comparison set-up;

FIG. 11 is a screen shot of a user interface showing a fourth comparison set-up;

FIG. 12 is a screen shot of a user interface showing a first comparison view;

FIG. 13 is a screen shot of a user interface showing a second comparison view;

FIG. 14 is a screen shot of a user interface showing a third comparison view;

FIG. 15 is a screen shot of a user interface showing a fourth comparison view; and

FIG. 16 is a screen shot of a user interface showing a fifth comparison view.

### DETAILED DESCRIPTION

As described in the summary section, the present specification provides a method, and associated system and computer program, for scanning a chemical processing vessel and diagnosing a problem within the chemical processing vessel and/or a problem with a process occurring within the chemical processing vessel. The method comprises: scanning the chemical processing vessel with at least one radiation source and at least one detector to generate density profile data for the chemical processing vessel; saving the density profile data; generating a representation of the chemical processing vessel; associating the density profile data with the representation of the chemical processing vessel whereby each data point of the density profile data is associated with a corresponding location along the representation of the chemical processing vessel indicating the location from which the data point was obtained; and displaying the representation of the chemical processing vessel alongside the associated density profile data on a user interface, wherein the user interface is configured to enable a user to select a portion of the representation of the chemical processing vessel on the user interface and to automatically display a corresponding portion of the density profile data in expanded form, whereby said portion of the density profile data can be analysed by the user in greater detail.

Advantageously, the method further comprises associating the saved density profile data with a date (and/or time) on which the density profile data was captured, wherein the user interface is configured to enable a user to simultaneously display density profile data captured on two or more different dates (and/or times) to identify changes in the density profile data associated with a representation of chemical processing vessel. For example, the user interface can be configured to enable a user to select a portion of the representation of the chemical processing vessel on the user interface and to automatically display a corresponding portion of the density profile data in expanded form for said two or more different dates, whereby said portion of the density profile data for said two or more different dates can be analysed by the user in greater detail to identify changes in said portion of the density profile data. The density profile data captured on two or more different dates may be displayed side-by-side and aligned such that adjacent density profile data corresponds to the same location along the chemical processing vessel. Alternatively, the density profile data captured on two or more different dates may be displayed in overlayed form and aligned such that adjacent or overlying density profile data corresponds to the same location along the chemical processing vessel.

The method, system, and computer program can provide a process diagnostics platform in the form of an online portal which offers interactive tower scan reporting with the ability to easily dive deeper into scanning data and compare historic scan data. Customer tower scan data is uploaded and collated. This provides a data source allowing a service provider to offer an online, in browser, interactive tower scan report. The interactive report gives the customer the ability to dive deeper into their scan data, with customisable report views, scanline filtering, zoom functionality along the tower's elevation, and commenting capability. Once historical data has been built up for a customer's tower asset, the interactive report can used to build a comparison between datasets by importing previous comparable reports on the tower and displaying historic data overlaid or side-by-side dependent on the view. The system displays reports in a format that allows quick and easy comparison of data between reports using normalisation of data against clear vapour bars. The system is configured to parse raw data and logic is built into the system to normalise data across multiple data sets enabling easier comparison.

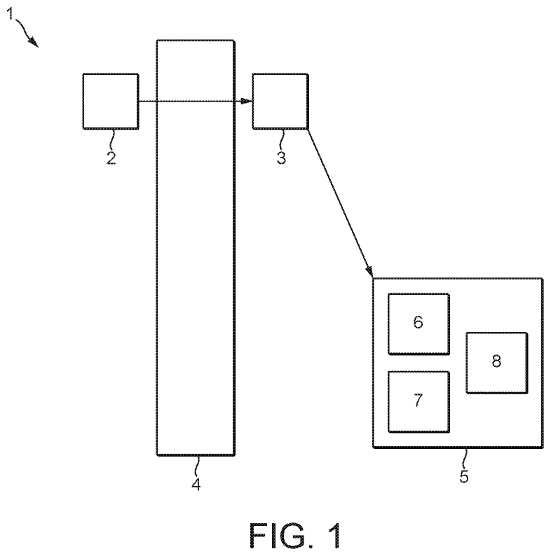

FIG. 1 shows a schematic representation of a scanning system for scanning a chemical processing vessel and diagnosing a problem within the chemical processing vessel and/or a problem with a process occurring within the chemical processing vessel. The scanning system comprises a scanning apparatus 1 including at least one radiation source 2 and at least one detector 3 configured to enable scanning of a chemical processing vessel 4 to generate density profile data for the chemical process vessel. In the configuration which is illustrated in FIG. 1, a single source 2 and a single detector 3 are positioned either side of the chemical processing vessel 4 such that gamma radiation passes through the vessel 4 from the source 2 to the detector 3. Attenuation of the gamma radiation as it passes through the vessel is dependent on the density of the material through which the radiation passes. By moving the source and detector along the vessel a density profile of the vessel can be generated, and this can be used to diagnose problems with the tower and/or the process operating in the tower without opening the tower and/or stopping the process. For example, it is possible to identify the location of different fluid layers having different densities in a multi-layer fluid column comprising, for example, layers of solid, aqueous, emulsion, oil, and/or gas phases. For certain chemical processes it is required to maintain a fluid surface or interface at a specific height within a tower. The gamma scanning technique allows the interior of a tower to be interrogated to determine correct operating conditions and/or diagnose a problem in the tower.

As an alternative to using a single radiation source and detector which are moved down the vessel in unison to measure a density profile of the vessel, an array of radiation sources and detectors can be provided extending down on opposite sides of the vessel to provide source/detector pairs at fixed locations down the vessel. In order to obtain the required measurement accuracy, such a system adopts a collimated design which ensures that each source/detector pair is focused at a particular elevation. In this way, a density profile of the vessel can be generated in a similar fashion to the method which uses a movable source and detector.

The scanning apparatus can also be configured to move around the circumference of the tower taking measurement at a plurality of radial directions around the tower. Reconstruction models then take this information and use it to generate an accurate image of the tower at that location. This has the advantage of generating a density map which can provide information about the tower wall thickness and integrity, the product flowing conditions, and the condition of any coating applied to the tower. CT scans can be performed at multiple heights down the tower to build a three-dimensional picture of the tower interior.

The scanning system further comprises a computing system 5 including a data storage 6 for storing the density profile data from the detector 3, a processor 7 for processing the density profile data, and a display 8 for displaying a user interface configured to enable a user to select and view the density profile data on the display 8. Data processing software is configured to generate the user interface and implement the method as described herein for diagnosing a problem within the chemical processing vessel and/or a problem with a process occurring within the chemical processing vessel. In particular, the data processing software is configured to generate a representation of the chemical processing vessel and associate the density profile data with the representation of the chemical processing vessel whereby each data point of the density profile data is associated with a corresponding location along the representation of the chemical processing vessel indicating the location from which the data point was obtained. The representation of the chemical processing vessel is displayed alongside the associated density profile data on the user interface. The user interface is configured to enable a user to select a portion of the representation of the chemical processing vessel on the user interface and to automatically display a corresponding portion of the density profile data in expanded form, whereby said portion of the density profile data can be analysed by the user in greater detail. The user interface is also configured to enable a user to select historic data sets for the same vessel, simultaneously view selected data sets, and simultaneously expand portions of the plurality of displayed data sets by selecting a portion of the representation of the chemical processing vessel on the user interface to identify differences in the data sets which may be indicative of a problem.

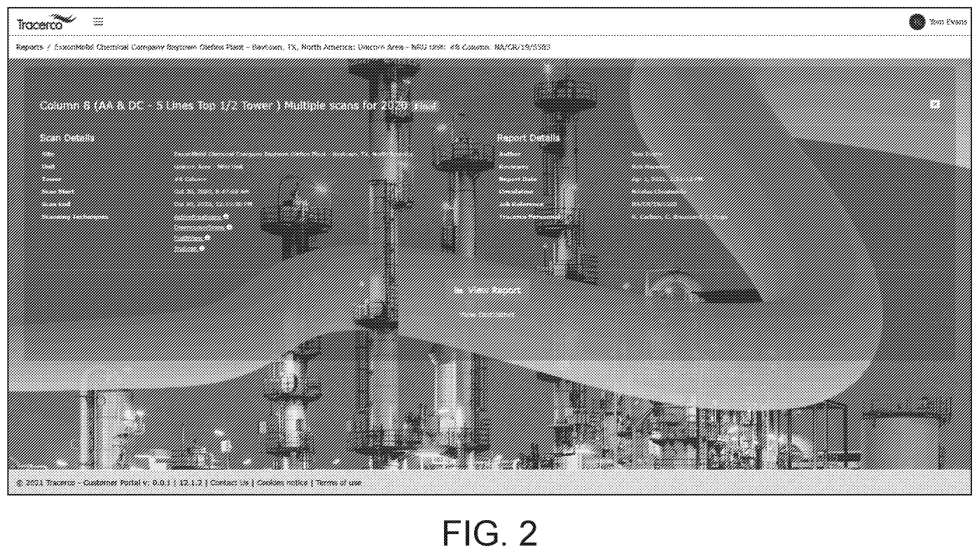

FIGS. 2 to 16 are screen shots of an example of a user interface showing various views of density profile data.

FIG. 2 shows a report coversheet, outlining the report meta data, including detailed start and end times for the scan as well as scanning techniques used. This provides a greater level of detail when compared to a standard PDF report coversheet, as it provides information to aid the cross-referencing of related data (such as operational data and process conditions) from a client's 3^{rd} party data collection system, and provides the user with up-front information about scanning techniques and other relevant information rather than embedding it in an overlooked report section.

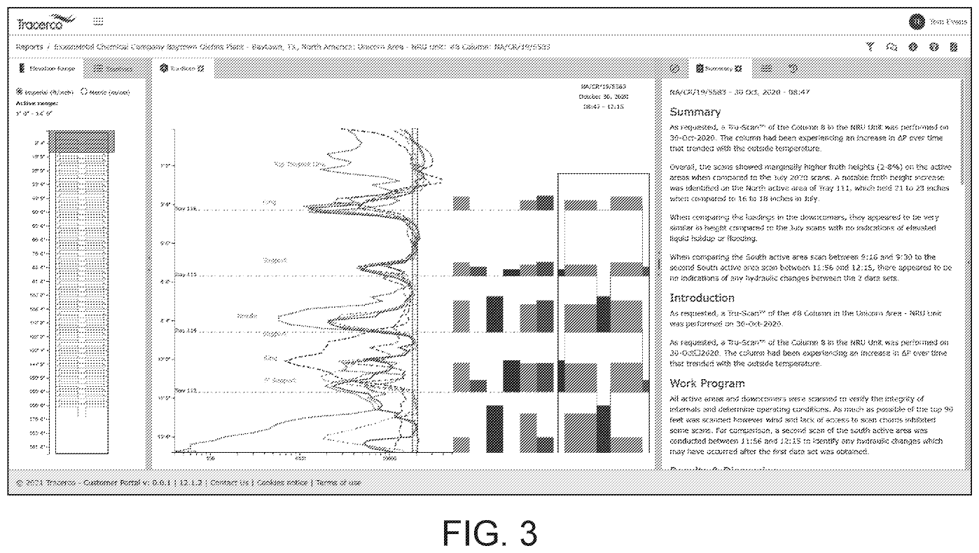

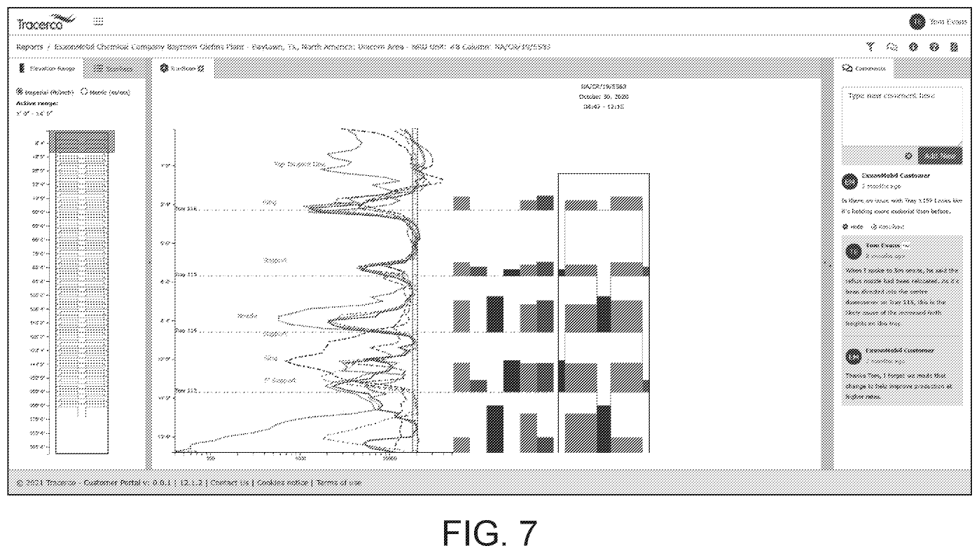

FIG. 3 shows a default report view when a user closes the coversheet and views the report content. The interface is split into four horizontally split sections (noting that only three are opened in FIG. 3) allowing the user to view and control report filtering, and view graphical and diagrammatical representations of data along with a textual summary. The filter section on the left-hand side allows the user to control the selected elevation as well as the scanlines selected. The two central split panes can be resized, collapsed and re-configured to display the user's preferred report content. The right-hand pane is collapsed in this figure (shown open in FIG. 7 with further explanation) and allows a user to leave comments and/or maintain a conversation history about the report. Compared to a standard PDF report, this gives the user the flexibility to configure the report layout to enable them to better interrogate the scan data and allows them to easily drill into sections of the tower elevation to gain a clear picture of the conditions inside their tower. A further advantage is the ability to be able to read the summary in a side-by-side view with the graphical count data, with the tower diagram visible for cross-referencing points of interest from the textual report summary.

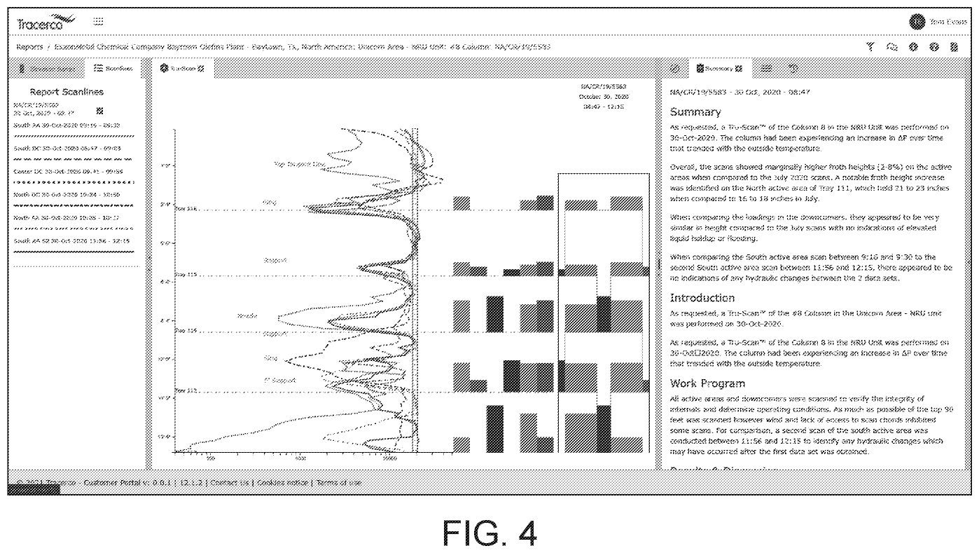

FIG. 4 shows a default report view, but with the filter pane toggled to show the report scanlines. This lists the available scanlines, with their title containing scan meta data and their line style and colour for cross referencing, enabling the user to toggle scanlines on and off to filter data which provides clear, concise visuals for areas of interest.

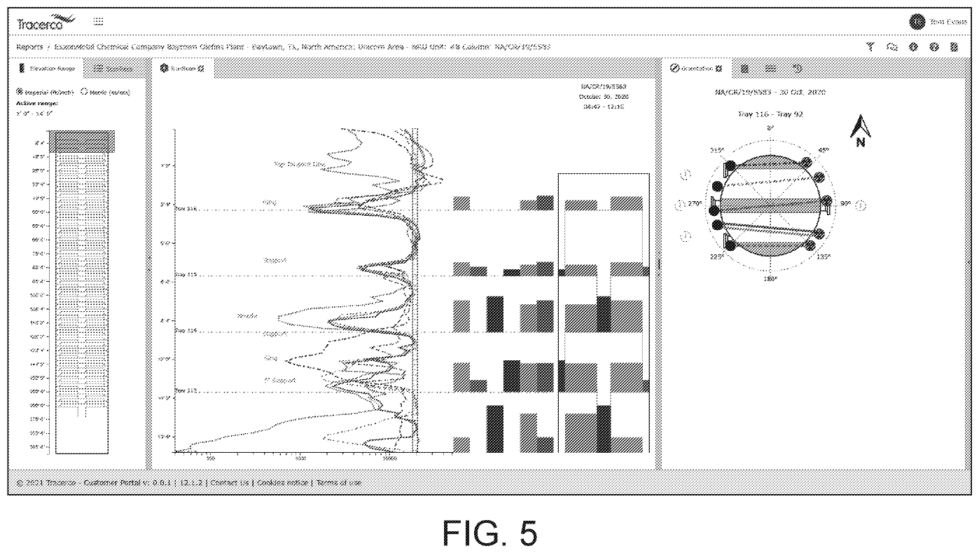

FIG. 5 shows the orientation tab active within the default report layout. This provides a birds-eye view of the positions of the radioactive source and detectors during the tower scans, cross referenced with the scanline styles and colours. This view is driven from the filters, so unlike a standard PDF report, this report component is interactive and allows filtering of orientation data by elevation and by scanline, enabling the user to easily understand how the scan lines relate to the configuration of their tower.

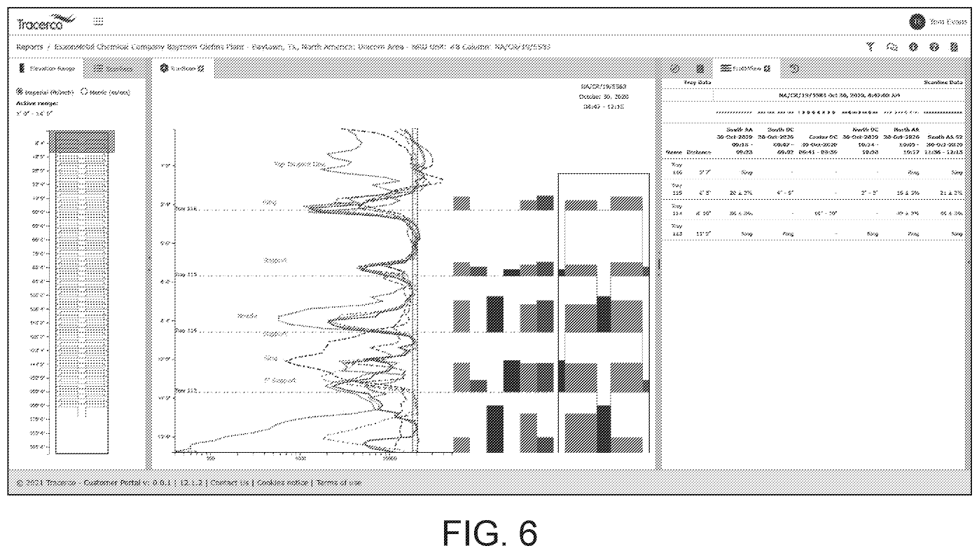

FIG. 6 shows FrothView™ data in a tabular format within the default report layout. This gives the user a representation of the froth heights in their tower in a format not provided in a standard PDF report. This component is interactive and allows filtering of froth height data by elevation and by scanline, enabling the user to easily interpret scan line data in the context of tray state within a trayed tower.

FIG. 7 shows the comments pane open with the second central report content pane closed. The comments component adds another layer of interactivity and detail to the report. Users can record conversations and notes here for future reference and as a discussion or decision log. The commenting system also allows a threaded reply to be added to top level comments. This is a beneficial addition as it enables collaboration inside a report.

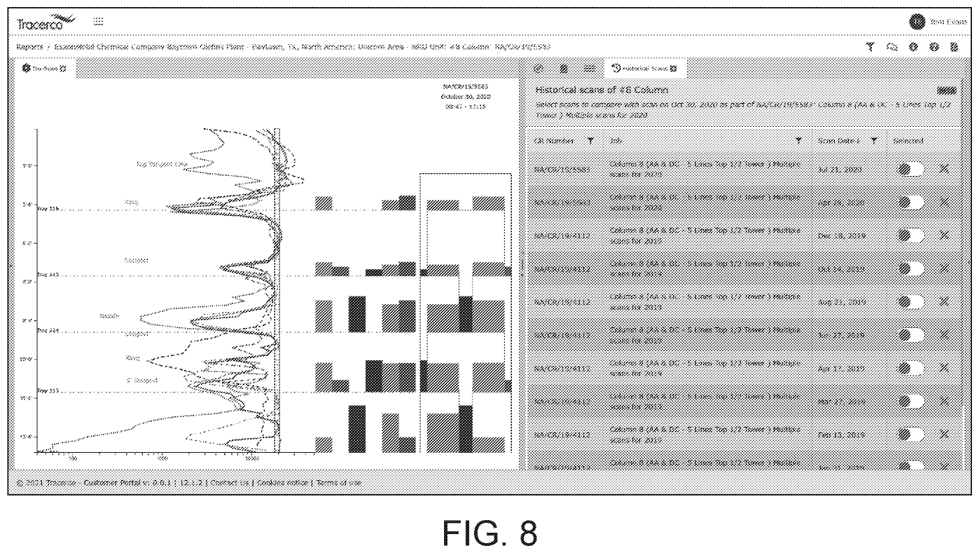

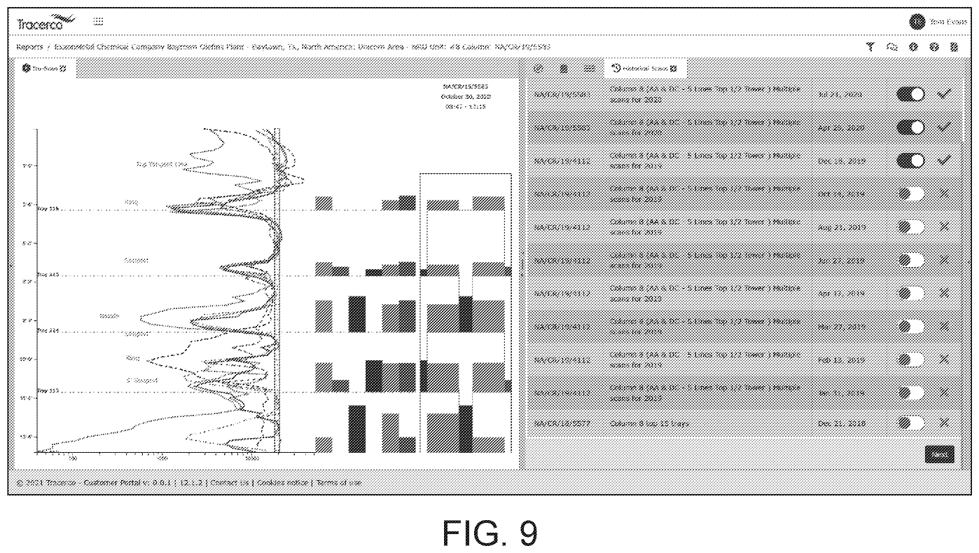

FIGS. 8 and 9 show the first step in historic comparison setup. FIG. 8 shows an initial list of historic data that is available and suitable for comparison based on the tower configuration. When historic data is present, the user can select one or more historic reports to add to the comparison. FIG. 9 shows three selected reports ready for the next step in the process of setting up a historic comparison. This component allows users to find relevant historic data without the need for searching through a document archive.

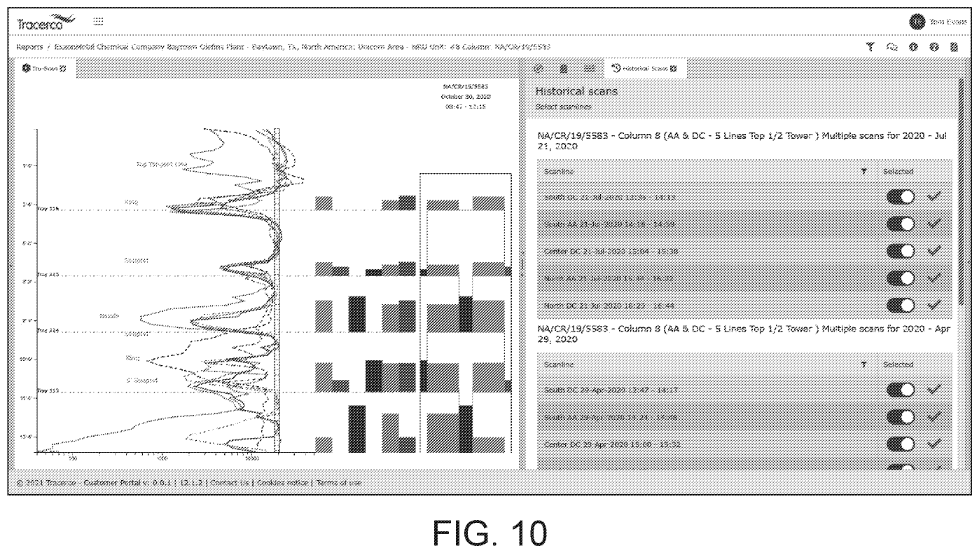

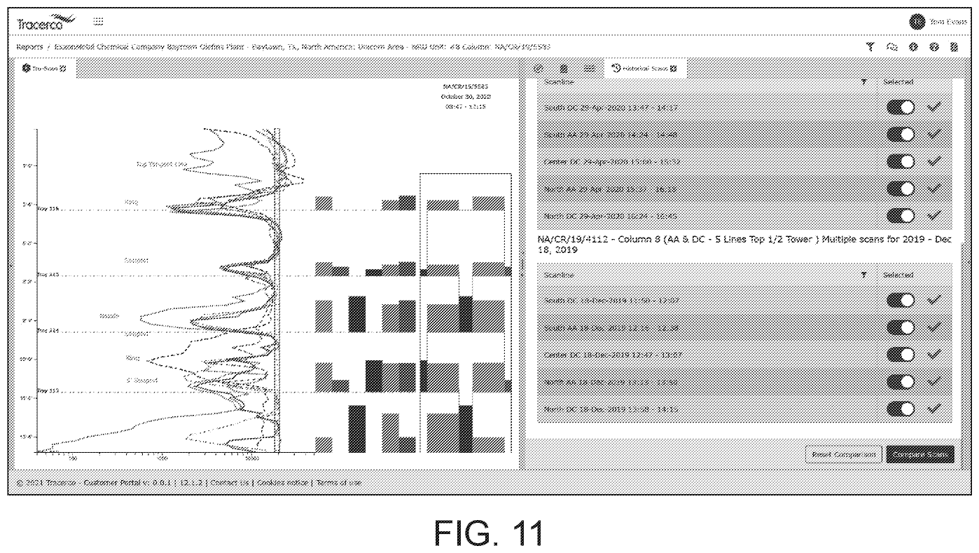

FIGS. 10 and 11 show the final step in historic comparison setup. The user is presented with groups of scanlines available per each historic report that was selected in the previous step. The user can select one or more scanline from each report to be added to the report content for comparison. This allows a user to be selective with the data to allow a direct comparison between scans without being forced to import a full dataset. The comparison is set up using on the fly single-point normalisation against global clear vapour bars between report datasets and negates the need for a user to perform any calculation which would be a requirement when trying to compare one or more PDF reports.

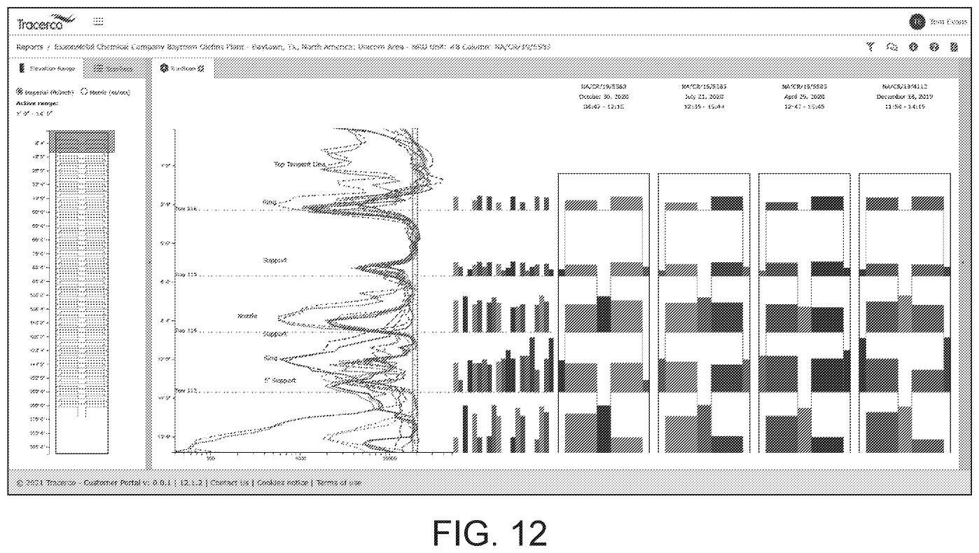

FIG. 12 shows an active historic comparison with the filter pane displaying an overview of the tower and a selected elevation. This allows the user to see the radiation count data overlaid on a single line graph, next to a bar chart representing froth heights with diagrams showing froth heights and bottoms levels superimposed onto a tower drawing representative of each historic scan report. As the historic data is displayed on a single report, the user has the benefit of being able to zoom into multiple data sets at the same time and can easily move up and down the elevation of the tower without having to manipulate multiple reports for comparison.

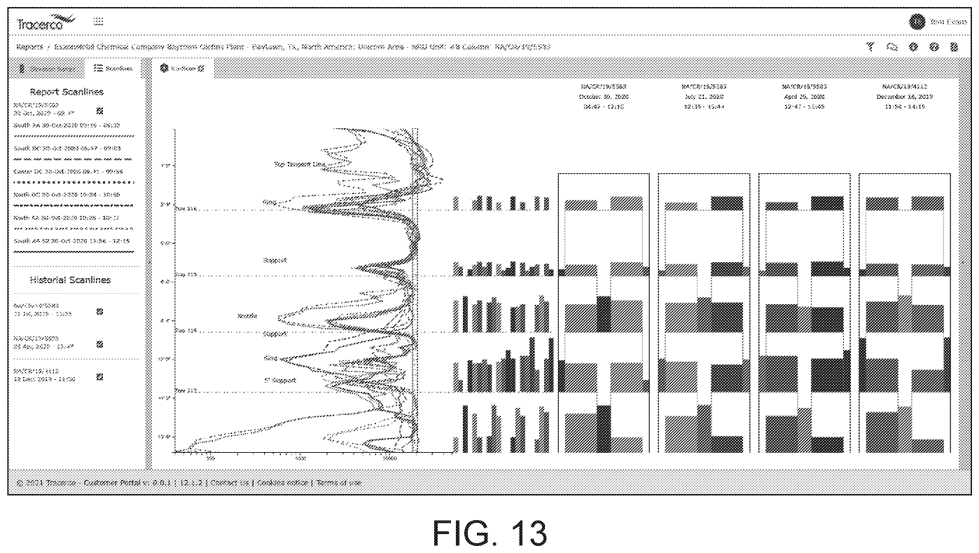

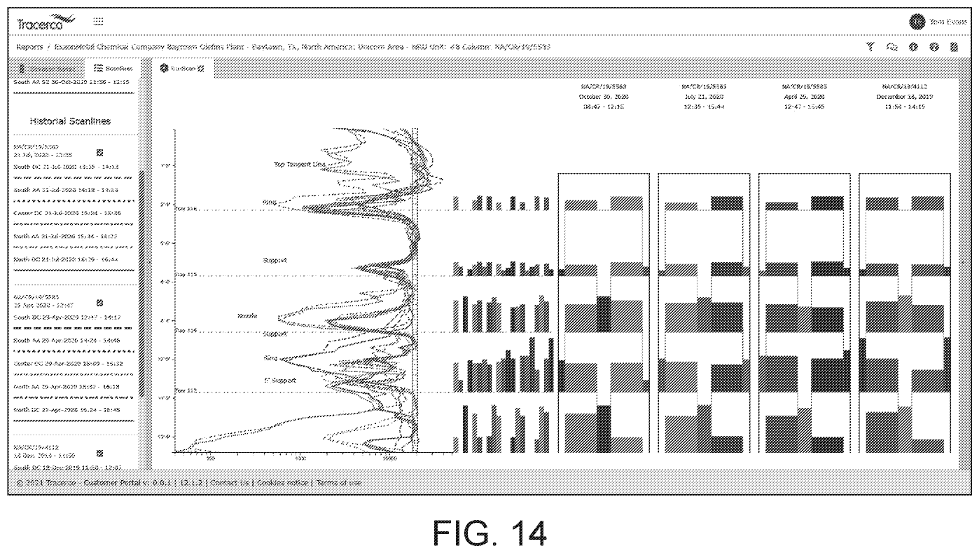

FIGS. 13 and 14 show an active historic comparison with the filter pane alongside showing the available scanlines from the current report and from the selected historic reports. FIG. 13 shows the historical scanlines in a collapsed accordion allowing all the scanlines for a report to be toggle on/off at once, with FIG. 14 displaying the historical scanlines in an expanded accordion showing the detail for each historic scanline. This functionality allows the user to easily compare historic scans and scanlines, with the ability to toggle scanlines on and off to filter data which provides clear, concise visuals for comparing historical data.

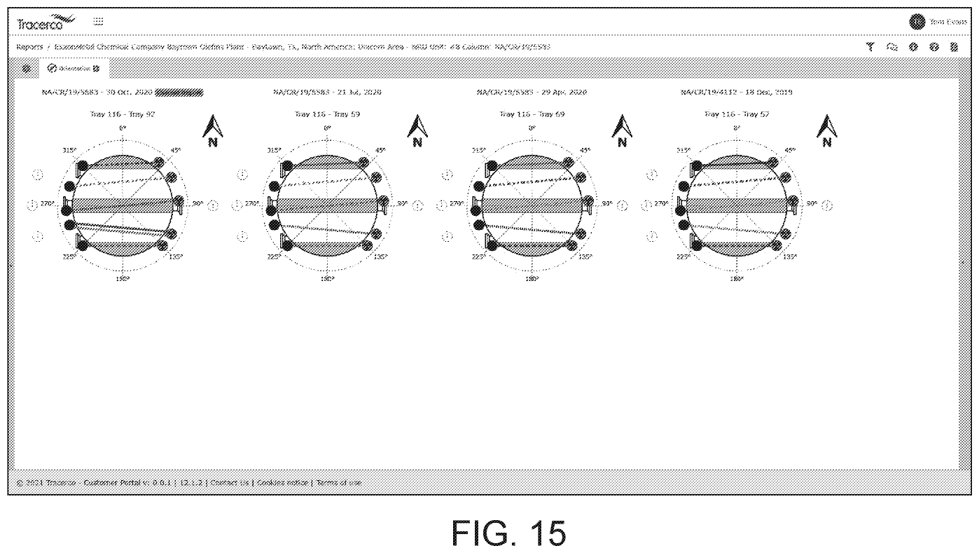

FIG. 15 shows orientations as part of an active historic comparison, displayed in a report configured as a single pane view with filter and comment panes collapsed. An orientation diagram is displayed for each report, allowing easy comparison between historic reports detailing the positions of source and detectors for each scan.

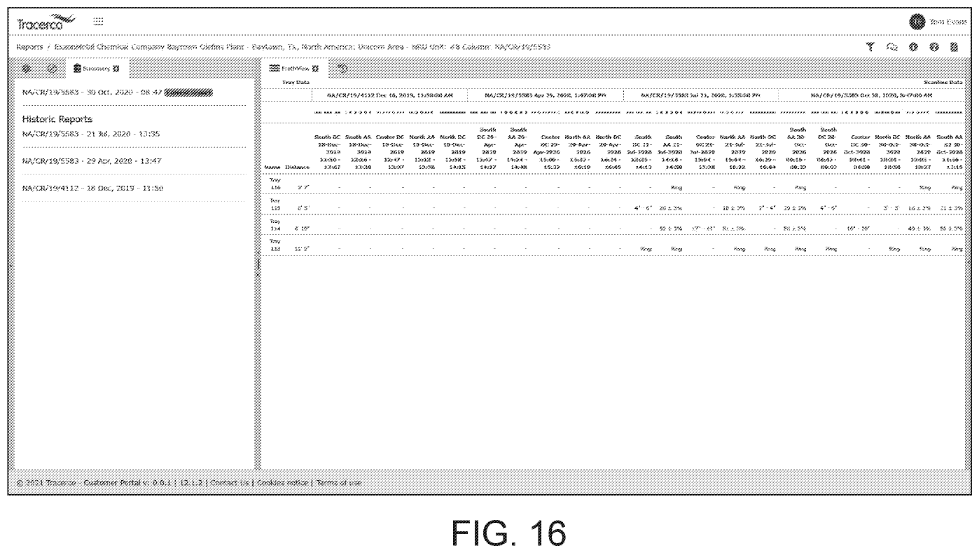

FIG. 16 shows textual summaries for multiple reports in an accordion format in the first report content pane, with tabular FrothView™ data in the second report content pane as part of an active historic comparison, with filter and comment panes collapsed. This allows a user to easily compare historical summaries and how froth heights differ per historic scan.

While this invention has been particularly shown and described with reference to certain examples, it will be understood by those skilled in the art that various changes in form and detail may be made without departing from the scope of the invention as defined by the appended claims.

1: A method of scanning a chemical processing vessel and diagnosing a problem within the chemical processing vessel and/or a problem with a process occurring within the chemical processing vessel, the method comprising:
scanning the chemical processing vessel with at least one radiation source and at least one detector to generate density profile data for the chemical processing vessel;
saving the density profile data;
generating a representation of the chemical processing vessel;
associating the density profile data with the representation of the chemical processing vessel whereby each data point of the density profile data is associated with a corresponding location along the representation of the chemical processing vessel indicating the location from which the data point was obtained;
displaying the representation of the chemical processing vessel alongside the associated density profile data on a user interface,
wherein the user interface is configured to enable a user to select a portion of the representation of the chemical processing vessel on the user interface and to automatically display a corresponding portion of the density profile data in expanded form, whereby said portion of the density profile data can be analysed by the user in greater detail.

2: A method according to claim 1,
further comprising associating the saved density profile data with a date on which the density profile data was captured,
wherein the user interface is configured to enable a user to simultaneously display density profile data captured on two or more different dates to identify changes in the density profile data associated with a representation of chemical processing vessel.

3: A method according to claim 2,
wherein the user interface is configured to enable a user to select a portion of the representation of the chemical processing vessel on the user interface and to automatically display a corresponding portion of the density profile data in expanded form for said two or more different dates, whereby said portion of the density profile data for said two or more different dates can be analysed by the user in greater detail to identify changes in said portion of the density profile data.

4: A method according to claim 2, wherein the density profile data captured on two or more different dates is displayed side-by-side and aligned such that adjacent density profile data corresponds to the same location along the chemical processing vessel.

5: A method according to claim 2, wherein the density profile data captured on two or more different dates is displayed in overlayed form and aligned such that adjacent density profile data corresponds to the same location along the chemical processing vessel.

6: A method according to claim 1,
wherein the representation of the chemical processing vessel displayed on the user interface is a longitudinal representation of the chemical process vessel.

7: A method according to claim 6,
wherein the user interface is configured to enable a user to select a portion of the longitudinal representation of the chemical processing vessel and to display a cross-sectional representation of the selected portion along with density profile data for said cross-sectional representation.

8: A method according to claim 7,
wherein the density profile data includes density data captured at different angular orientations around the chemical processing vessel, and the user interface is configured to display density data captured at different angular orientations around the chemical processing vessel for the selected portion of the longitudinal representation of the chemical processing vessel.

9: A method according to claim 1, wherein the or each radiation source is a gamma radiation source.

10: A method according to claim 1, wherein the chemical processing vessel is a distillation tower, storage tank, or separator vessel.

11: A method according to claim 1,
wherein the method further comprises controlling the chemical processing vessel and/or the process occurring within the chemical processing vessel based on said analysis.

12: A scanning system for scanning a chemical processing vessel and diagnosing a problem within the chemical processing vessel and/or a problem with a process occurring within the chemical processing vessel, the scanning system comprising:
a scanning apparatus comprising at least one radiation source and at least one detector configured to enable scanning of the chemical processing vessel to generate density profile data for the chemical processing vessel;
a computing system comprising a data storage for storing the density profile data, a processor for processing the density profile data, and a display for displaying a user interface configured to enable a user to select and view the density profile data on the display; and
data processing software configured to generate the user interface and implement the method according to any preceding claim for diagnosing a problem within the chemical processing vessel and/or a problem with a process occurring within the chemical processing vessel.

13: A computer program configured to implement the method according to claim 1 for diagnosing a problem within a chemical processing vessel and/or a problem with a process occurring within the chemical processing vessel.
